(19) United States
(12) Patent Application Publication
(10) Pub. No.: US 2021/0090020 A1
(43) Pub. Date: Mar. 25, 2021

(54) IN-TRANSIT PACKAGE DELIVERY

(71) Applicant: INTERNATIONAL BUSINESS MACHINES CORPORATION, Armonk, NY (US)

(72) Inventors: Andrea Young, Austin, TX (US); John Kaufmann, Austin, TX (US); Borja Canseco, Austin, TX (US)

(21) Appl. No.: 16/580,284

(22) Filed: Sep. 24, 2019

(51) Int. Cl. G06Q 10/08

(52) U.S. Cl. CPC G06Q 10/0835; G06Q 10/0833; G06Q 10/0832

(57) ABSTRACT

A method, computer system, and computer program product for in-transit package delivery is provided. The embodiment may determine whether package dimensions satisfy one or more preconfigured conditions. The embodiment may also, in response to determining the package dimensions satisfy the one or more preconfigured conditions, receive real-time location data and travel data for a user recipient and a courier. The embodiment may further determine a target delivery destination and target delivery time window. The embodiment may also transmit a delivery notification to the user recipient and the courier.

### BACKGROUND

The present invention relates generally to the field of computing, and more particularly to in-transit package delivery.

A courier is an individual, or a company, that performs delivery services of message, packages, or letters from one individual or location to another individual or location. Collectively, couriers currently perform millions of package deliveries to customers each day. Due to technological advancements, such as global positioning systems (GPS), robotic sorting, and autonomous vehicles, the courier industry is able to more efficiently and quickly process and fulfill customer deliveries.

### SUMMARY

According to one embodiment, a method, computer system, and computer program product for in-transit package delivery is provided. The embodiment may determine whether package dimensions satisfy one or more preconfigured conditions. The embodiment may also, in response to determining the package dimensions satisfy the one or more preconfigured conditions, receive real-time location data and travel data for a user recipient and a courier. The embodiment may further determine a target delivery destination and target delivery time window. The embodiment may also transmit a delivery notification to the user recipient and the courier.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart of an in-transit package delivery process according to at least one embodiment.

FIG. 3 is an example of an in-transit package delivery according to at least one embodiment.

FIG. 4 is a block diagram of components of a computing device of the system for enhancing voice quality for online meetings of FIG. 1 according to at least one embodiment.

FIG. 5 depicts a cloud computing environment according to an embodiment of the present invention.

FIG. 6 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to in-transit package delivery. The following described exemplary embodiments provide a system, method, and program product to, among other things, update the package delivery location for the courier, at the time of delivery, to a user's real-time location. Therefore, the present embodiment has the capacity to improve the technical field of in-transit package delivery by conserving resources consumed in the courier delivery process as well as improve efficiency of courier delivery systems.

As previously described, a courier is an individual, or a company, that performs delivery services of messages, packages, or letters from one individual or location to another individual or location. Collectively, couriers currently perform millions of package deliveries to customers each day. Due to technological advancements, such as global positioning systems (GPS), robotic sorting, and autonomous vehicles, the courier industry is able to more efficiently and quickly process and fulfill customer deliveries.

With the increasing prevalence of online shopping and faster delivery of such purchases at a convenient time and location, an individual with existing plans in need of the item being delivered may be required to reorganize their schedule to accommodate the delivery. From a fulfillment perspective, retails and couriers expend countless resources yearly in replacing stolen items as a consequence of couriers permitting deliveries to be left at insecure locations, such as doorsteps or roadside mailboxes. As such, it may be advantageous to, among other things, allow individuals to receive deliveries on-the-go by redirecting the delivery location to the user's current location.

According to at least one embodiment, a person-to-person (contrary to person-to-location) delivery using live vehicle geolocations may be implemented. At the time of delivery, the current location of the user and the delivery courier may be requested through on-board vehicle GPS systems or a user device with GPS capabilities. A location convenient for the both the user and the courier may be identified using the user's inputted navigation route, speed of the user and courier vehicles, the distance between the user and courier vehicles, current traffic conditions, and nearby business addresses. Upon both the user and the courier accepting the location when prompted, navigation instructions may be transmitted to the corresponding GPS systems and navigation to the identified location may begin. In at least one embodiment, when the user vehicle and the courier vehicle satisfy a distance threshold, each party may be presented with vehicle or individual screening information to allow each party to validate the exchange. For example, the user may be shown a picture or physical description of the courier delivering the package and the courier may be provided a description of the user vehicle, such as make, model, vehicle color, or license plate number.

Such an embodiment may also minimize the need for users to reschedule their appointments in order to receive a delivery that the user does not wish to be left unattended as well as decrease the risk of a delivery being stolen from the delivery location. In an alternate embodiment, piecemeal delivery systems may benefit from such an invention since the need for a single driver to complete an entire delivery may be eliminated. In yet another embodiment, an algorithm may be applied to build a delivery route with multiple delivery couriers.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to deliver courier packages to a recipient individual while both the recipient and courier are in-transit based on real-time GPS location data.

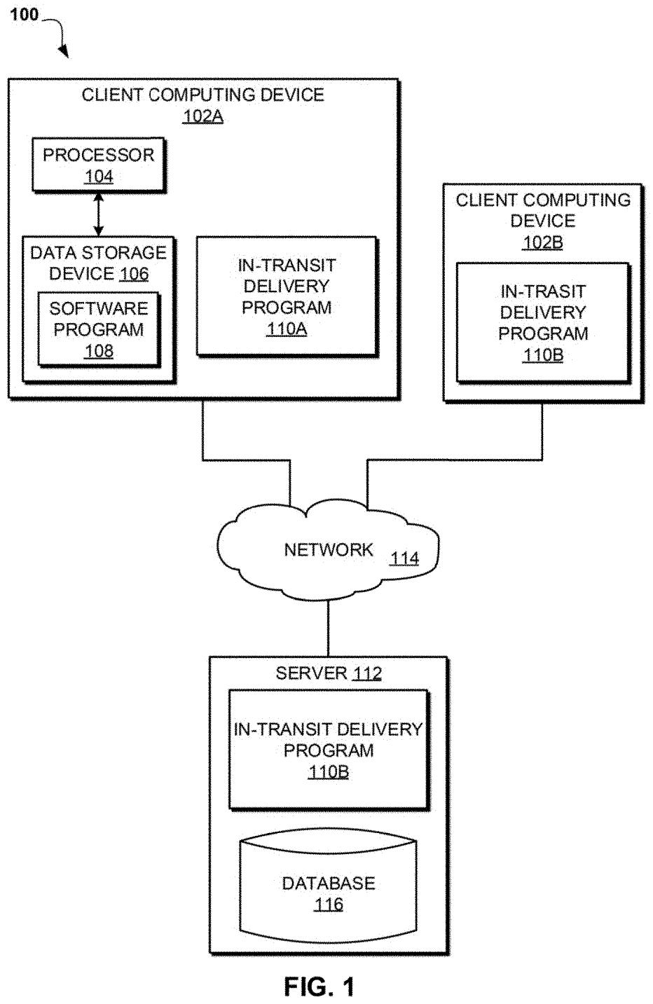

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

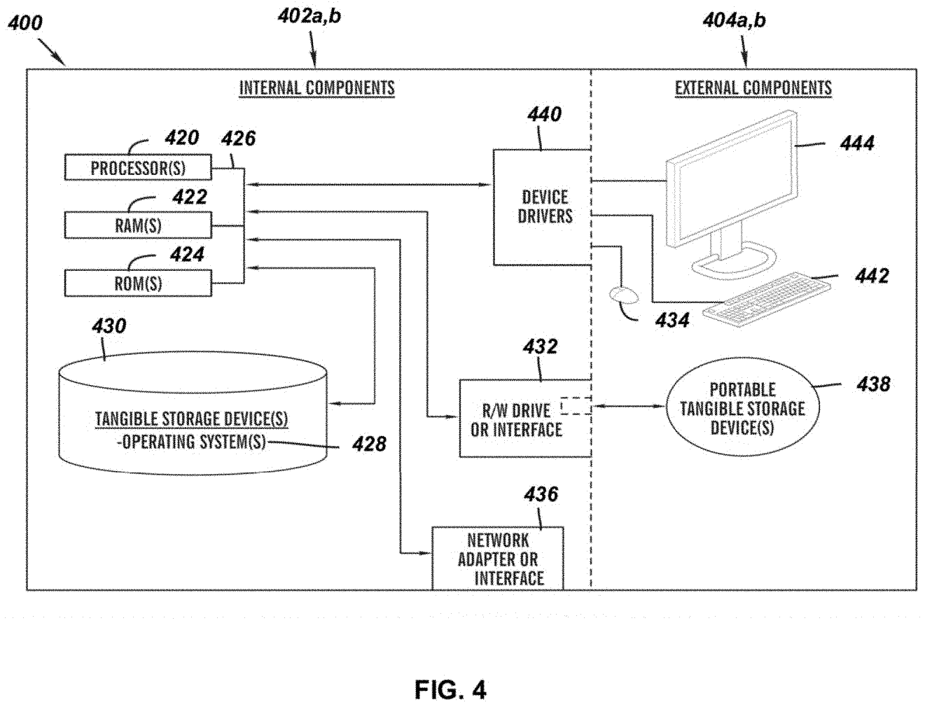

Client computing device 102A, 102B may include a processor 104 and a data storage device 106 that is enabled to host and run a software program 108 and an in-transit delivery program 110A, 110B and communicate with the server 112 via the communication network 114, in accordance with one embodiment of the invention. Client computing device 102A, 102B may be, for example, a mobile device, a telephone, a personal digital assistant, a netbook, a laptop computer, a tablet computer, a desktop computer, or any type of computing device capable of running a program and accessing a network. As will be discussed with reference to FIG. 4, the client computing device 102A, 102B may include internal components 402a and external components 404a, respectively.

The server computer 112 may be a laptop computer, netbook computer, personal computer (PC), a desktop computer, or any programmable electronic device or any network of programmable electronic devices capable of hosting and running an in-transit delivery program 110C and a database 116 and communicating with the client computing device 102A, 102B via the communication network 114, in accordance with embodiments of the invention. As will be discussed with reference to FIG. 4, the server computer 112 may include internal components 402b and external components 404b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

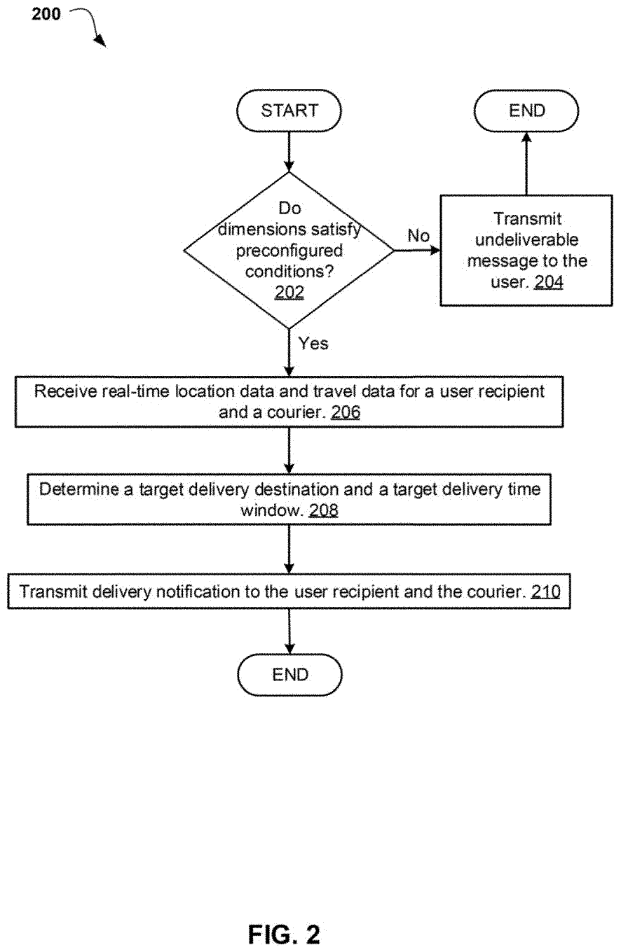

According to the present embodiment, the in-transit delivery program 110A, 110B, 110C may be a program capable of identifying a convenient location for a recipient and courier to exchange a package based on recipient and courier navigation routes, recipient and courier vehicle speeds, distance between the recipient and courier, current traffic conditions, and nearby business addresses suitable for the package exchange. Additionally, the in-transit delivery program 110A, 110B, 110C may be capable of providing verification information of each party, such as vehicle physical description or individual physical description. The in-transit delivery method is explained in further detail below with respect to FIG. 2.

Referring now to FIG. 2, an operational flowchart illustrating an in-transit delivery process 200 is depicted according to at least one embodiment. At 202, the in-transit delivery program 110A, 110B, 110C determines whether package dimensions satisfy preconfigured conditions. When a user places an order for an item from a retailer, either in an online eCommerce marketplace or through a telephone ordering system or representative, the retailer may prepare and ship the item for delivery to the user as a recipient of the package carrying the item. Shipping times for an item vary from several days or weeks to same-day. In situations where the shipped package is to be delivered that day, the user may utilize the in-transit delivery program 110A, 110B, 110C to replace the original shipping destination to that of the user's current location as opposed to simply updating the shipping destination. For example, currently, a user may be capable of updating the shipping destination of a package prior to the package being out-for-delivery on the anticipated date of delivery. Utilizing the in-transit delivery program 110A, 110B, 110C, the user may be capable of updating the delivery destination to the user's current location.

When the user makes a request for an in-transit delivery of the package, the in-transit delivery program 110A, 110B, 110C may determine whether preconfigured conditions, such as the properties of the shipped item or the size of the delivery vehicle(s), to ensure the item is capable of delivery from person-to-person. For example, an item weighing greater than 50 lbs. may be impractical for a courier to deliver to an individual since the individual may not be capable of lifting the package due to the weight of the package. Similarly, a large item exceeding a preconfigured size threshold or preconfigured volume threshold may not be capable of properly fitting into a standard passenger vehicle. For the in-transit delivery program 110A, 110B, 110C to determine whether a package exceeds the preconfigured size threshold or preconfigured volume threshold, the user vehicle dimensions may be required. For example, a user driving a pickup truck may be capable of transporting a much larger package than a user driving a compact passenger car. Therefore, the corresponding preconfigured size threshold and preconfigured volume threshold for the pickup truck may be larger than the preconfigured size threshold or preconfigured volume threshold for the compact passenger car. If the in-transit delivery program 110A, 110B, 110C determines the package dimensions satisfy the preconfigured conditions (step 202, “Yes” branch), the in-transit delivery process 200 may continue to step 206 to receive real-time location data and travel data for the user recipient and the courier transporting the package. If the in-transit delivery program 110A, 110B, 110C determines the package dimensions do not satisfy the preconfigured conditions (step 202, “No” branch), the in-transit delivery process 200 may continue to step 204 to transmit an undeliverable message to the user. In at least one other embodiment, the preconfigured conditions may also include the fragility of the package or the item within the package, the hazardous nature of the item within the package, and a storage temperature sensitivity of the item within the package. For example, an item with a high storage temperature sensitivity may include items that must remain cold during transport, such as refrigerated foodstuffs.

Furthermore, the in-transit delivery program 110A, 110B, 110C may retain the size dimensions of all courier deliver vehicles to ensure that the courier delivery vehicle intended to deliver the package to the user is of sufficient size to transport the package. For example, in one embodiment, in-transit delivery program 110A, 110B, 110C may allow for a first courier delivery vehicle to exchange the package to a second courier delivery vehicle to ensure efficiency of the delivery process since the updated, in-transit delivery location to the recipient user may not be in the delivery route of the first delivery vehicle but may be in the route of the second delivery vehicle. Therefore, the in-transit delivery program 110A, 110B, 110C may need to determine that the second delivery vehicle is dimensionally large enough to transport the recipient package.

Then, at 204, if the package dimensions do not satisfy the preconfigured conditions, the in-transit delivery program 110A, 110B, 110C transmits an undeliverable message to the user. If the in-transit delivery program 110A, 110B, 110C determines the preconfigured conditions do not allow for in-transit delivery of the package, the in-transit delivery program 110A, 110B, 110C may transmit a notification to the user device, such as client computing device 102A, 102B, stating the reason the package is not capable of, or unavailable for, in-transit delivery. For example, if the package is 5 feet tall and the recipient user vehicle designated as the delivery location is a compact passenger vehicle, the in-transit delivery program 110A, 110B, 110C may determine that the package is undeliverable and transmit a notification to the user device stating the package is undeliverable in-transit due to the size of the user's designated vehicle compared to the package size. When the in-transit delivery program 110A, 110B, 110C determines in-transit delivery is not possible, the original package delivery location is maintained by the courier.

Next, at 206, if the package dimensions satisfy the preconfigured conditions, the in-transit delivery program 110A, 110B, 110C receives real-time location data and travel data for a user recipient and a courier. Upon determination in-transit delivery is capable, the in-transit delivery program 110A, 110B, 110C may obtain GPS coordinates from the user device utilized to make the in-transit delivery request or another user computing device associated with the user, based on a user authorizing location data to be shared with the in-transit delivery program 110A, 110B, 110C. For example, if the user made the in-transit delivery request from a smartphone, the in-transit delivery program 110A, 110B, 110C may obtain the user locational data from a navigation system associated with the smartphone. In another example, should the user make the in-transit delivery request from a desktop computer within the user's residence but the user wishes to or designates the delivery location to be a retail establishment, the in-transit delivery program 110A, 110B, 110C may obtain the live user GPS coordinates from the user's smartphone since the computing device used to make the in-transit delivery request (i.e., the user desktop computer) is incapable of maintaining live GPS coordinates as to the user's location. In at least one other embodiment, the in-transit delivery program 110A, 110B, 110C may obtain the user live GPS coordinates by utilizing an onboard navigation system within a user vehicle. Additionally, the in-transit delivery program 110A, 110B, 110C may also obtain the courier live GPS location in a similar fashion as to how the user recipient's live GPS coordinates are obtained.

The in-transit delivery program 110A, 110B, 110C may also obtain travel data associated with both the user recipient and the courier. The travel data may include the user recipient's geolocation, the user recipient's navigation destination(s), the delivery courier's geolocation, the delivery courier's navigation destination(s), area traffic conditions within a preconfigured radius of the user recipient, traffic conditions within a preconfigured radius of the courier, current area weather conditions within a preconfigured radius of the user recipient, current area weather conditions within a preconfigured radius of the courier, forecast area weather conditions within a preconfigured radius of the user recipient, and forecast weather conditions within a preconfigured radius of the courier.

Then, at 208, the in-transit delivery program 110A, 110B, 110C determines a target delivery destination and a target delivery time window. Utilizing the real-time location data and travel data for the user recipient and the courier, the in-transit delivery program 110A, 110B, 110C identifies an optimal in-transit delivery location and delivery time window. The in-transit delivery program 110A, 110B, 110C may identify the in-transit travel destination as a neutral meetup location for the courier and user recipient based on the number of nearby locations to the courier and user recipient, the distance from each meeting point to each party, and each party's ultimate navigation destination. When considering each nearby location, the in-transit delivery program 110A, 110B, 110C may take into account each nearby location's business type (e.g., governmental, commercial, industrial, etc.), operating hours, and third-party review aggregator score. The third-part review aggregator score may be obtained by the in-transit delivery program 110A, 110B, 110C through a database of such review scores or an internet search result that aggregates individual user review scores. For example, if a shopping center with reputable store reviews is along the courier′ delivery route and the user recipient travel data indicates that the user recipient travel destination is a store within the shopping center, the in-transit delivery program 110A, 110B, 110C may identify the shopping center as the target in-transit delivery destination and calculate the time window as an estimated time when the courier will be within the area of the shopping center based on traffic conditions, weather conditions, and preceding deliveries along the courier's delivery route.

In at least one embodiment, the in-transit delivery program 110A, 110B, 110C may continuously calculate whether the identified target delivery destination and calculated time window for delivery remain accurate. For example, in the previously described example, if the user recipient visits a different shopping center before travelling to the shopping center originally identified as the target in-transit delivery destination and the different shopping center is a better destination to conduct the in-transit delivery, the in-transit delivery program 110A, 110B, 110C may update the in-transit delivery destination to the second shopping center and recalculate the estimated time window for delivery then transmit the updated in-transit delivery destination and updated, estimated time window to the user recipient and courier. In another example, if a traffic accident occurs along the travel route for either the courier or the user recipient, the in-transit delivery program 110A, 110B, 110C may update either or both the navigation route to the in-transit delivery destination and the estimated time window for either or both the user recipient and the courier.

Then, at 210, the in-transit delivery program 110A, 110B, 110C transmits a delivery notification to the user recipient and the courier. Once the in-transit delivery destination and delivery time window are identified and calculated, respectively, the in-transit delivery program 110A, 110B, 110C transmits a delivery notification to the user recipient and the courier that includes this updated information. In at least one embodiment, the in-transit delivery program 110A, 110B, 110C may automatically update navigation information in a vehicle onboard GPS navigation system, an externally-connected GPS navigation system, or other computing device-installed GPS navigation system.

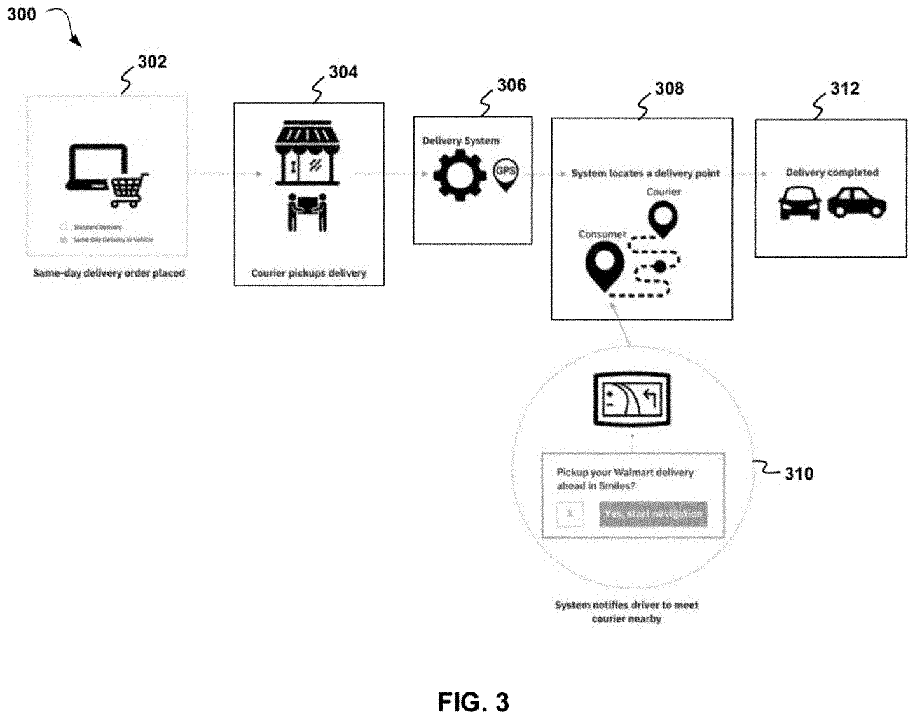

Referring now to FIG. 3, an example of an in-transit package delivery 300 is depicted according to at least one embodiment. At 302, a user may place an online order from an eCommerce marketplace to be delivered same-day. At 304, a courier arrives at the designated shipping facility and pickups up the package for delivery to the user. At 306, the in-transit delivery program 110A, 110B, 110C may determine that the user has enabled in-transit delivery of the package and, at 308, identifies an in-transit delivery destination at which the courier can meet the user to exchange the package. At 310, the in-transit delivery program 110A, 110B, 110C may transmit the identified in-transit delivery destination to the user and courier. In at least one embodiment, the in-transit delivery program 110A, 110B, 110C may prompt the user, through an onboard GPS navigation system, to add a new destination or via point to the user's route. At 312, the in-transit delivery program 110A, 110B, 110C may determine that the courier and the user are within a preconfigured distance based on the location coordinates of each party's navigational device and transmit validation information to each party, such as vehicle or physical description information. Upon successful delivery of the package, the courier may update the delivery status through the eCommerce marketplace.

It may be appreciated that FIGS. 2 and 3 provides only an illustration of one implementation and does not imply any limitations with regard to how different embodiments may be implemented. Many modifications to the depicted environments may be made based on design and implementation requirements. For example, the in-transit delivery program 110A, 110B, 110C may be implemented through different couriers, rather than a courier-to-user embodiment described above, and scaled using different legs of transport with multiple dynamic stopping routes. For example, a regional courier may deliver a package to a train transporting the package cross-country while the regional courier is already en-route to other deliveries and the train is scheduled to arrive as a specified time or is delayed to a different time or location. In another embodiment, the in-transit delivery program 110A, 110B, 110C may implement a trust score that may be computed and maintained for users and couriers alike. The trust score may be influenced by the ability of each party to verify that they own the vehicle they opted to use for the delivery among other factors including historical delivery data, such as previous successful deliveries or previous failed deliveries. If a trust score fails below a preconfigured threshold, the user may be prevented from using the in-transit delivery system

FIG. 4 is a block diagram 400 of internal and external components of the client computing device 102 and the server 112 depicted in FIG. 1 in accordance with an embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

The data processing system 402, 404 is representative of any electronic device capable of executing machine-readable program instructions. The data processing system 402, 404 may be representative of a smart phone, a computer system, PDA, or other electronic devices. Examples of computing systems, environments, and/or configurations that may represented by the data processing system 402, 404 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 402 a,b and external components 404 a,b illustrated in FIG. 4. Each of the sets of internal components 402 include one or more processors 420, one or more computer-readable RAMs 422, and one or more computer-readable ROMs 424 on one or more buses 426, and one or more operating systems 428 and one or more computer-readable tangible storage devices 430. The one or more operating systems 428, the software program 108 and the in-transit delivery program 110A, 110B in the client computing device 102 and the in-transit delivery program 110C in the server 112 are stored on one or more of the respective computer-readable tangible storage devices 430 for execution by one or more of the respective processors 420 via one or more of the respective RAMs 422 (which typically include cache memory). In the embodiment illustrated in FIG. 4, each of the computer-readable tangible storage devices 430 is a magnetic disk storage device of an internal hard drive. Alternatively, each of the computer-readable tangible storage devices 430 is a semiconductor storage device such as ROM 424, EPROM, flash memory or any other computer-readable tangible storage device that can store a computer program and digital information.

Each set of internal components 402 a,b also includes a R/W drive or interface 432 to read from and write to one or more portable computer-readable tangible storage devices 438 such as a CD-ROM, DVD, memory stick, magnetic tape, magnetic disk, optical disk or semiconductor storage device. A software program, such as the in-transit delivery program 110A, 110B, 110C, can be stored on one or more of the respective portable computer-readable tangible storage devices 438, read via the respective R/W drive or interface 432, and loaded into the respective hard drive 430.

Each set of internal components 402 a,b also includes network adapters or interfaces 436 such as a TCP/IP adapter cards, wireless Wi-Fi interface cards, or 3G or 4G wireless interface cards or other wired or wireless communication links. The software program 108 and the in-transit delivery program 110A, 110B in the client computing device 102 and the in-transit delivery program 110C in the server 112 can be downloaded to the client computing device 102 and the server 112 from an external computer via a network (for example, the Internet, a local area network or other, wide area network) and respective network adapters or interfaces 436. From the network adapters or interfaces 436, the software program 108 and the in-transit delivery program 110A, 110B in the client computing device 102 and the in-transit delivery program 110C in the server 112 are loaded into the respective hard drive 430. The network may comprise copper wires, optical fibers, wireless transmission, routers, firewalls, switches, gateway computers and/or edge servers.

Each of the sets of external components 404 a,b can include a computer display monitor 444, a keyboard 442, and a computer mouse 434. External components 404 a,b can also include touch screens, virtual keyboards, touch pads, pointing devices, and other human interface devices. Each of the sets of internal components 402 a,b also includes device drivers 440 to interface to computer display monitor 444, keyboard 442, and computer mouse 434. The device drivers 440, R/W drive or interface 432, and network adapter or interface 436 comprise hardware and software (stored in storage device 430 and/or ROM 424).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

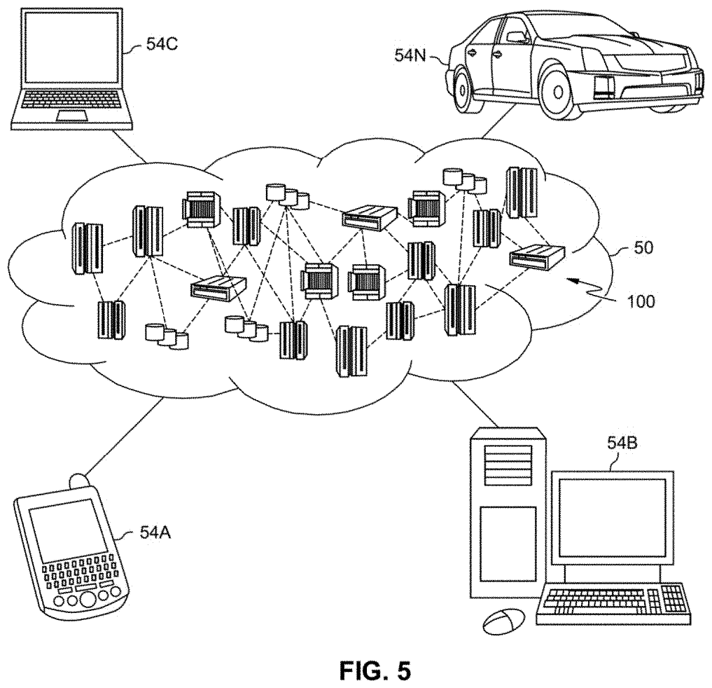

Referring now to FIG. 5, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 100 and cloud computing environment 50 can communicate with any type of computerized device over any type of network and/or network addressable connection (e.g., using a web browser).

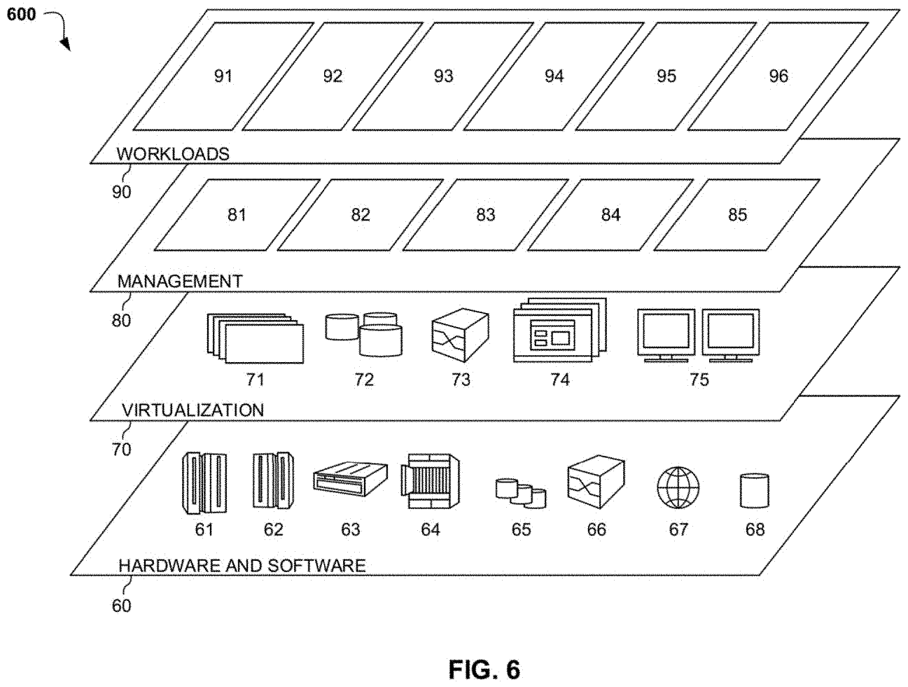

Referring now to FIG. 6, a set of functional abstraction layers 600 provided by cloud computing environment 50 is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and in-transit delivery 96. In-transit delivery 96 may relate to identifying a location where a courier and user recipient may facilitate a package exchange, different from the original shipping location, based on real-time location and travel data associated with each party.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for in-transit package delivery, the method comprising:
determining, by a processor, whether package dimensions satisfy one or more preconfigured conditions;
in response to determining the package dimensions satisfy the one or more preconfigured conditions, receiving real-time location data and travel data for a user recipient and a courier;
determining a target delivery destination and target delivery time window; and
transmitting a delivery notification to the user recipient and the courier.

2. The method of claim 1, further comprising:
in response to determining the package dimensions do not satisfy the one or more preconfigured conditions, transmitting a message to the user recipient.

3. The method of claim 1, wherein the one or more preconfigured conditions are selected from a group consisting of package size, package volume, package fragility, fragility of an item within the package, a hazardous nature of an item within the package, storage temperature sensitivity of an item within the package, and a size of a courier vehicle.

4. The method of claim 2, wherein the notification informs the user recipient that the package is unavailable for in-transit delivery along with a reason of unavailability for in-transit delivery.

5. The method of claim 1, wherein the travel data is selected from a group consisting of user recipient geolocation, one or more navigation destinations of the user recipient, courier geolocation, one or more navigation destinations of the courier, area traffic conditions within a preconfigured radius of the user recipient, traffic conditions within a preconfigured radius of the courier, current area weather conditions within a preconfigured radius of the user recipient, current area weather conditions within a preconfigured radius of the courier, forecast area weather conditions within a preconfigured radius of the user recipient, and forecast weather conditions within a preconfigured radius of the courier.

6. The method of claim 1, further comprising:
in response to the courier and the user recipient being within a preconfigured distance of the target delivery destination, transmitting verification information to the courier and the user recipient.

7. The method of claim 6, wherein the verification information provides to each party one or more items of a vehicle physical description or an individual physical description associated with the other party.

8. A computer system for in-transit package delivery, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
determining whether package dimensions satisfy one or more preconfigured conditions;
in response to determining the package dimensions satisfy the one or more preconfigured conditions, receiving real-time location data and travel data for a user recipient and a courier;
determining a target delivery destination and target delivery time window; and
transmitting a delivery notification to the user recipient and the courier.

9. The computer system of claim 8, further comprising:
in response to determining the package dimensions do not satisfy the one or more preconfigured conditions, transmitting a message to the user recipient.

10. The computer system of claim 8, wherein the one or more preconfigured conditions are selected from a group consisting of package size, package volume, package fragility, fragility of an item within the package, a hazardous nature of an item within the package, storage temperature sensitivity of an item within the package, and a size of a courier vehicle.

11. The computer system of claim 9, wherein the notification informs the user recipient that the package is unavailable for in-transit delivery along with a reason of unavailability for in-transit delivery.

12. The computer system of claim 8, wherein the travel data is selected from a group consisting of user recipient geolocation, one or more navigation destinations of the user recipient, courier geolocation, one or more navigation destinations of the courier, area traffic conditions within a preconfigured radius of the user recipient, traffic conditions within a preconfigured radius of the courier, current area weather conditions within a preconfigured radius of the user recipient, current area weather conditions within a preconfigured radius of the courier, forecast area weather conditions within a preconfigured radius of the user recipient, and forecast weather conditions within a preconfigured radius of the courier.

13. The computer system of claim 8, further comprising:
in response to the courier and the user recipient being within a preconfigured distance of the target delivery destination, transmitting verification information to the courier and the user recipient.

14. The computer system of claim 13, wherein the verification information provides to each party one or more items of a vehicle physical description or an individual physical description associated with the other party.

15. A computer program product for in-transit package delivery, the computer program product comprising:
one or more computer-readable tangible storage medium and program instructions stored on at least one of the one or more tangible storage medium, the program instructions executable by a processor capable of performing a method, the method comprising:
determining whether package dimensions satisfy one or more preconfigured conditions;
in response to determining the package dimensions satisfy the one or more preconfigured conditions, receiving real-time location data and travel data for a user recipient and a courier;
determining a target delivery destination and target delivery time window; and
transmitting a delivery notification to the user recipient and the courier.

16. The computer program product of claim 15, further comprising:
in response to determining the package dimensions do not satisfy the one or more preconfigured conditions, transmitting a message to the user recipient.

17. The computer program product of claim 15, wherein the one or more preconfigured conditions are selected from a group consisting of package size, package volume, package fragility, fragility of an item within the package, a hazardous nature of an item within the package, storage temperature sensitivity of an item within the package, and a size of a courier vehicle.

18. The computer program product of claim 16, wherein the notification informs the user recipient that the package is unavailable for in-transit delivery along with a reason of unavailability for in-transit delivery.

19. The computer program product of claim 15, wherein the travel data is selected from a group consisting of user recipient geolocation, one or more navigation destinations of the user recipient, courier geolocation, one or more navigation destinations of the courier, area traffic conditions within a preconfigured radius of the user recipient, traffic conditions within a preconfigured radius of the courier, current area weather conditions within a preconfigured radius of the user recipient, current area weather conditions within a preconfigured radius of the courier, forecast area weather conditions within a preconfigured radius of the user recipient, and forecast weather conditions within a preconfigured radius of the courier.

20. The computer program product of claim 15, further comprising:
in response to the courier and the user recipient being within a preconfigured distance of the target delivery destination, transmitting verification information to the courier and the user recipient.
